(19) United States
(12) Patent Application Publication
(10) Pub. No.: US 2011/0225161 A1
(43) Pub. Date: Sep. 15, 2011

(54) Categorizing products

(75) Inventors: Ling Zhong, Hangzhou (CN); Hualei Liu, Hangzhou (CN)

(73) Assignee: Alibaba Group Holding Limited

(21) Appl. No.: 12/932,659

(22) Filed: Mar. 1, 2011

(30) Foreign Application Priority Data
Mar. 9, 2010 (CN) 201010122141.2

(51) Int. Cl. G06F 17/30

(52) U.S. Cl. 707/740; 707/E17.09

(57) ABSTRACT

Categorizing products includes: extracting titles for a plurality of products from acquired data; segmenting the titles into phrases; determining respective scores for the phrases; composing a first word sequence for a first one of the plurality of products with at least one of the phrases based at least in part on the determined respective scores for the phrases; comparing the first word sequence to a second word sequence for a second one of the plurality of products; and combining the first one and the second one of the plurality of products into a category of products based at least in part on the comparison.

### CROSS REFERENCE TO OTHER APPLICATIONS

This application claims priority to People's Republic of China Patent Application No. 201010122141.2 entitled METHOD AND DEVICE FOR CATEGORIZING DATA filed Mar. 9, 2010 which is incorporated herein by reference for all purposes.

### FIELD OF THE INVENTION

This application relates to the field of data processing and particularly to a method and a system for categorizing product data.

### BACKGROUND OF THE INVENTION

On an electronic commerce website, various data that describe products on the website are typically stored in the form of text, data tables, etc. Due to the large number of products that are usually featured at an electronic website, the descriptive data of all the products form a large body of information content. Thus, there is an issue regarding how the data should be effectively managed, especially for similar products.

It is common in various electronic commerce websites to categorize various data of products using a clustering technique. The typical clustering technique sorts data regarding products into categories (e.g., similar products are sorted into the same category) based on a series of preset rules and conditions.

An example of a commonly used clustering method is hierarchical clustering. This clustering hierarchical clustering method refers to a bottom-up policy. In a typical bottom-up policy, each of the objects to be categorized is initially regarded as a separate atom cluster, and these atom clusters are then combined to form new clusters at higher levels until all of the objects that belong to the same category are clustered into the same group or until a termination condition is satisfied.

However, to use the aforementioned clustering method to sort the data of an electronic commerce website would require extensive data processing and leads to inefficiency of system resources.

### BRIEF DESCRIPTION OF THE DRAWINGS

Various embodiments of the invention are disclosed in the following detailed description and the accompanying drawings.

FIG. 1 is a diagram showing an embodiment of a system for categorizing products;

FIG. 2 is a flow diagram showing an embodiment of a process for categorizing products;

FIG. 3 is a flow diagram showing another embodiment of the process of categorizing products;

FIG. 4 is a diagram showing an embodiment of a system for categorizing and using product data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Categorizing products is disclosed. In some embodiments, product data is acquired and the titles of the products mentioned in the product data are extracted. In some embodiments, the attribute information of the products is also extracted from the product data. The extracted information is segmented into phrases. A score is determined for each phrase based at least in part on a historical occurrence frequency of the phrase. A set comprising one or more phrases is selected for the products and composed into a word sequence. The composed word sequence for each product is compared with the word sequences of other products. Products with similar word sequences are combined into a set of products under one category.

In some embodiments, combining products with similar word sequences into a set of products under one category also includes combining the related data of the products of that category (e.g., as accompanying product data that describes the category of products).

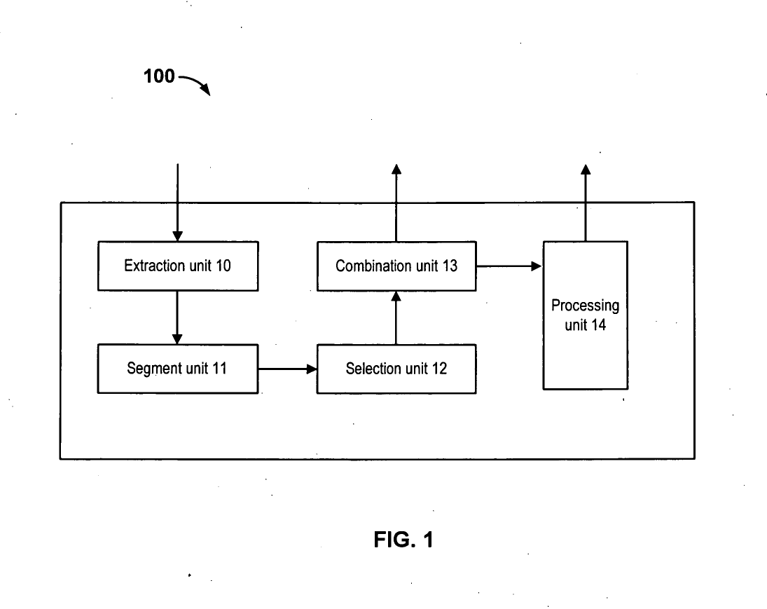

FIG. 1 is a diagram showing an embodiment of a system for categorizing products. In the example shown, system 100 includes extraction unit 10, segment unit 11, selection unit 12, combination unit 13, and processing unit 14.

System 100 may be implemented using one or more computing devices such as a personal computer, a server computer, a handheld or portable device, a flat panel device, a multi-processor system, a microprocessor based system, a set-top box, a programmable consumer electronic device, a network PC, a minicomputer, a large-scale computer, a special purpose device, a distributed computing environment including any of the foregoing systems or devices, or other hardware/software/firmware combination that includes one or more processors, and memory coupled to the processors and configured to provide the processors with instructions.

The units can be implemented as software components executing on one or more processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The units may be implemented on a single device or distributed across multiple devices. The functions of the units may be merged into one another or further split into multiple sub-units.

Extraction unit 10 is configured to acquire data that are related to products to be categorized. Extraction unit 10 is also configured to extract the titles of the products from the acquired data. In some embodiments, extraction unit 10 is configured to also extract attribute information of the products from the acquired data.

Segment unit 11 is configured to segment each of the titles of the products into one or more phrases, where each phrase includes one or more words. The segment unit is further configured to determine a score for each phrase that represents the historical occurrence frequency of the phrase.

Selection unit 12 is configured to select the phrases with scores that satisfy a preset condition for each product and compose them into a word sequence for the product.

Combination unit 13 is configured to compare the word sequences composed for the products against each other. In some embodiments, combination unit 13 is configured to determine which products have similar word sequences and combine the products with similar corresponding word sequences into one category of products. In some embodiments, for the products with similar word sequences, combination unit 13 also combines the related data (e.g., attribute information, other descriptive data) of those products of the same category (e.g., into a body of data that describes the category of products).

Processing unit 14 is configured to set and store an identifier corresponding to each of the categories of products that is determined by combination unit 13.

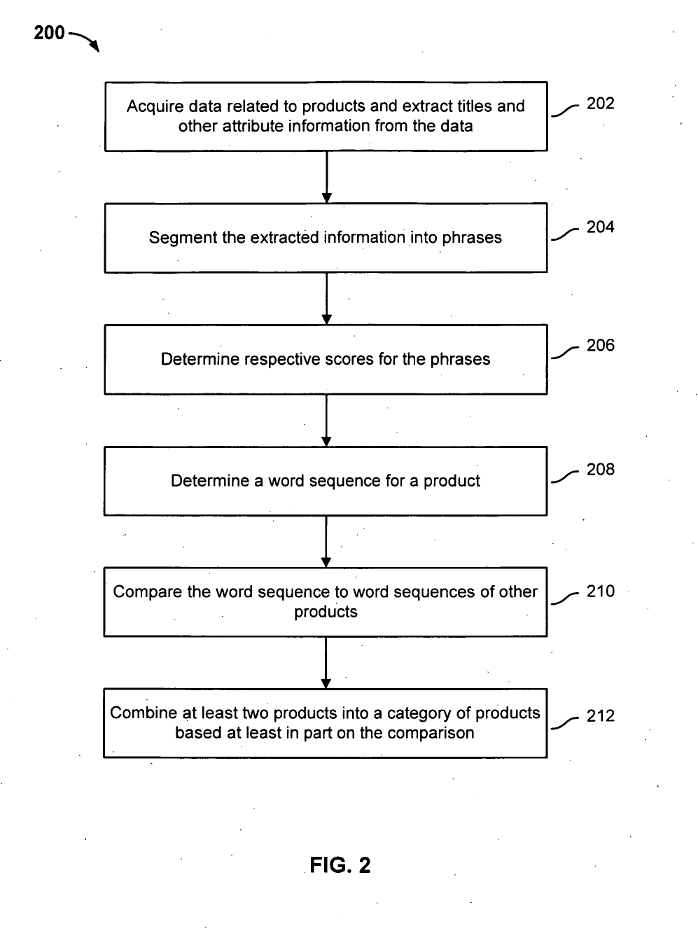

FIG. 2 is a flow diagram showing an embodiment of a process for categorizing products. In some embodiments, process 200 is implemented on a system such as 100 of FIG. 1.

At 202, data related to products to be categorized are acquired and the titles and other attribute information of the products are extracted.

In some embodiments, in an electronic commerce website, data related to a product is input at the website manually (e.g., by an operator of the website or a registered user). For example, a user can access a webpage at the website that features fields into which the user can input data related to a product. Then, the contents of the webpage may be transmitted to a server. The server then extracts the title and other attribute information from the contents. The server also segments the extracted titles into phrases.

In some embodiments, product data is acquired periodically and/or automatically to perform a categorization of products (e.g., to update the categorization stored for the electronic commerce website). In some embodiments, the product data is acquired by a server that is associated with the electronic commerce website (e.g., the server supports the platform of the website and stores at least some of the content for the website). For example, the server can acquire the product data after such data is uploaded to the website.

In various embodiments, the title of a product includes a keyword that accurately describes the product, so it is desirable to extract the title of the product. Examples of data related to a product include title, price, and other information related to model, year, manufacturer, etc. For example, a title of a product that is a hairdryer can be “Hairdryer of Model D3506 by brand HairShine.”

In various embodiments, attribute information of a product includes detailed descriptions of the product. For example, the attribute information of the hairdryer can include the time that the product was released on the market, the model and color of the hairdryer, and a popularity score. In some embodiments, an attribute and a corresponding attribute value are indicated by identifiers that represent the attribute and the corresponding value of the attribute. In some embodiments, an attribute and a corresponding attribute value are represented as a pair by the following denotation: attribute identifier: attribute value identifier. For example, if an attribute of color of a product is Green, it can be denoted as Attribute A: 2000, where A is an identifier of the attribute of color, and 2000 is an identifier of the attribute value of Green. In some embodiments, similarities between both titles and attribute information of different products are considered during combining the products into one or more groups (e.g., where each group is associated with a category). Thus, in some embodiments, both titles and attribute information of the products are extracted in step 200.

At 204, the titles of the products are segmented into phrases.

In some embodiments, the extracted title and/or attribute information of a product is segmented into one or more phrases, where each phrase includes at least one word. In some embodiments, a title is segmented into one or more phrases based at least on discernable meanings of the one or more phrases. In some embodiments, segmentation of titles is performed based on a set of predetermined rules, where a rule determines which individual word can be deemed as a phrase and which groups of words can be deemed as a phrase. For example, the title of the product “Hairdryer of Model D3506 with Brand HairShine” is segmented into the phrases of “Brand HairShine”, “Model D3506”, and “Hairdryer”.

In some embodiments, segmentation of titles and/or attribute information into phrases also includes discarding certain phrases. For example, phrases that indicate brands and the type of a product (e.g., “Brand HairShine” and “Model D3506”) are kept at the end of the segmentation process. In contrast, phrases that tend to not be germane to the categorization of the products (e.g., “certified product”, “sales”, and “special price”) are removed at the end of the segmentation process. In some embodiments, which phrases are discarded is determined based on using historical reference information that is stored in a database.

In some embodiments, the titles and the attribute information of the products are segmented into phrases using tools implemented on platforms such as Hadoop distributed computing system. In some embodiments, a Hadoop program is executed in a Hadoop distributed architecture (e.g., in a computing cluster composed of 50 to 300 machines).

At 206, respective scores are determined for the phrases. In some embodiments, a score is determined for each phrase that is produced by the segmentation and that is not discarded. In some embodiments, the score of a phrase represents the historical occurrence frequency of the phrase. The historical occurrence frequency of a phrase includes one or more of the following: the number of times that users of the associated electronic commerce website have searched for the phrase, the number of times the phrase has been included in the title information input by users, and distribution probabilities.

At 208, a word sequence is determined for a product. In some embodiments, a word sequence is formed with phrases segmented for the product. In some embodiments, the phrases to be included in a word sequence are selected based on their determined scores according to a preset condition. For example, a preset condition may require the selection of two phrases from the title of a product with the highest score(s) and five words in the attribute information with the highest score(s).

At 210, word sequences corresponding to the products are compared. The word sequences that were composed for the products in step 206 are compared against each other. In some embodiments, the word sequence of a product is compared against the word sequence of every other product in the acquired product data. In some embodiments, a match percentage is determined by each comparison. The match percentage determines how similar two word sequences (and their respective products) are. In some embodiments, if the match percentage for a comparison is greater than a certain threshold, then the two products are considered to be similar.

For example, if two word sequences were identical (e.g., each word sequence has exactly the same phrases), then the match percentage would be 100%. Assuming that the threshold match percentage is 95%, then the word sequences and their respective two products are deemed to be similar.

At 212, at least two products are combined into a category of products based at least in part on the comparison. Based on the comparison of step 210, similar products are sorted and combined into the same category. In some embodiments, a category of products is a set of products that have word sequences that are similar to each other's. Because the word sequences of the products are similar to each other, the products are considered to be similar to each other as well. In other words, a word sequence is considered to adequately represent the corresponding product. In some embodiments, a set of products that are combined into one category are stored together in a database.

For example, based on the comparison of step 210, the word sequences of 15 products are deemed to be similar (e.g., the word sequence of each of the product is deemed to be similar to the word sequence of every other product). In this example, the 15 products are sorted into one category.

In some embodiments, for products that are sorted and combined into the same category, their respective product data are also combined (e.g., into one body of descriptive data) and stored for that category of products. For the example, the combined product data of the products for the same category can be used to describe all the products of that category. The products that are combined into the same category and their combined product data may be stored in the same text file or data table, for instance.

In some embodiments, in managing a category of products, the combined product data for the category is used to characterize the category of products. For example, the combined product data can be used in a visual presentation of the products of the associated category. Or the combined product data can be modified to change the description of the products of the associated category. Also, the combined product data can be returned in response to a search for products within the associated category of products.

In some embodiments, a unique category identifier is set for each of the categories of products that are identified. The categories of products are stored with their respective unique category identifiers so that they can be looked up by such identifiers. For example, each unique category identifier can be stored with the corresponding set of products (e.g., using the title or other product identifying information of the products) and their combined product data.

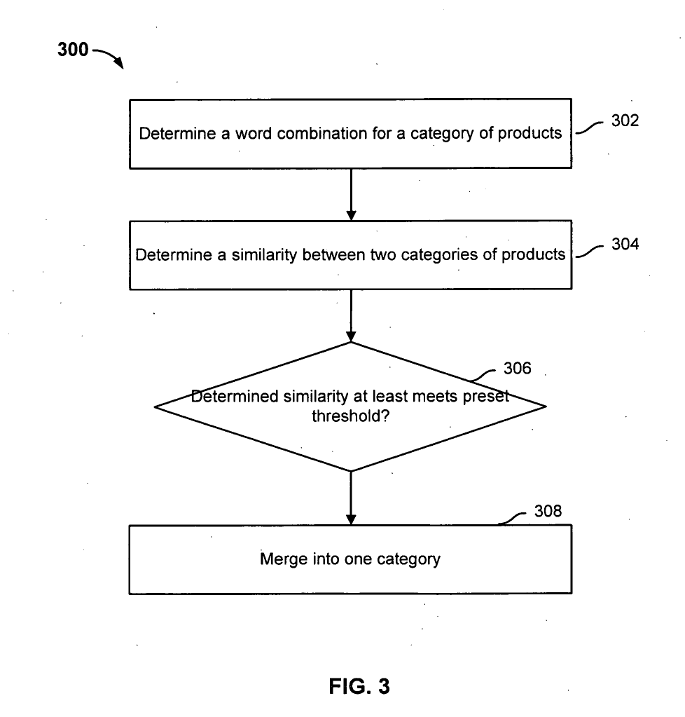

FIG. 3 is a flow diagram showing another embodiment of the process of categorizing products. In some embodiments, steps 302 to 306 occur subsequent to an iteration of process 200 of FIG. 2.

Process 300 may be performed to improve the accuracy of the categorization results of process 200. Process 300 may help to merge categories of products that include similar products but were sorted into different categories in process 200 because the relied upon data included different titles (e.g., as input by users) for the same product. Process 300 may be performed any number of times to improve the overall accuracy of the categorization process.

For the following embodiment of steps 302 to 306, it is assumed that at least two categories of products have been created after an iteration of process 200.

At 302, a word combination is determined for a category of products.

A word combination for a category of products refers to a string of phrases that represents the category of products and also the determined respective scores for the string of phrases. A word combination may be chosen for a category of products in various ways. In one example, if all the products of a category corresponded to the same word sequence, then that word sequence is used as the word combination for that category. For example, products corresponding to the word sequences that all include the phrases of “Brand HairShine”, “Red”, and “DF0753” are categorized into the same category and therefore “Brand HairShine, Red, DF0753” can be taken as the word combination for that category of products.

In another example, all the products of a category do not correspond to the same word sequence but all correspond to word sequences that contain several of the same phrases. In that scenario, a string of the phrases that are common to all the products in the category can be taken as the word combination for that category of products.

At 304, the similarity between the two categories of products is determined.

In some embodiments, the similarity between two categories is determined using the word combinations of those two categories of products. For example, the similarity can be determined by the following formula:

$$Similarity = {e}^{- λ 1 * \vert TD 1 - TD 2 \vert} * {e}^{- λ 2 * \vert prop 1 - prop 2 \vert} * \frac{1}{1 + {e}^{- [ a - max ( n 1 - n 2 ) ] / b}}$$

In the above formula, TD1 and TD2 represent the respective word combinations of the two categories of products. For example:

TD1=(phrase11,score11),(phrase12,score12),(phrase13,score13)

TD2=(phrase21,score21),(phrase22,score22),(phrase23,score23)

where “phraseXX” represents a phrase, and “scoreYY” represents a respective score.

Further, prop1 and prop2 represent respective values of primary attributes corresponding to the two categories of products. As used herein, a primary attribute refers to an important attribute of a particular product. For example, the primary attributes of a mobile phone include its brand and model while its color and weight are general (e.g., non-primary) attributes. In some embodiments, the primary attributes for a particular product are stored and accessed in process 300 for determining which values to use for prop1 and prop2. In some embodiments, the similarity is calculated from a law of cosines calculation. The larger the calculated similarity is, the more that the two products are similar.

Further, λ1 and λ2 are coefficients that are selected to assign weights to the title and attribute. λ1 and λ2 represent two coefficients that respectively indicate whether the title or the attribute is of more importance to calculation of the similarity (e.g., because TD1 and TD2 are formed using phrases segmented from title information and prop1 and prop2 are values of attributes). For example, when λ1=2 and λ2=1, it indicates that the importance of the title is twice as that of the attribute.

Further, a and b represent preset parameters, and n1 and n2 represent the numbers of products that are respectively included in the two categories of products that are being compared. The parameters of a and b control the similarity value and thus influence whether the two categories of products will be combined. For example, when the two categories of products both respectively include a large number of products, the similarity value may be adjusted by changing the values of a and b to make the similarity value calculated from

$$\frac{1}{1 + {e}^{- [ a - max ( n 1 - n 2 ) ] / b}}$$

become smaller, which results in a lower probability that the two categories of products will be combined.

For example, if a=50, b=20, n1=100 and n2=10, the similarity=e^{-λ1}*^{|TD1-TD2|}*e^{-λ2}*^{|prop1-prop2|}*1/(1+̂(50/20))=1/(1±e^{̂}2.5)=0.07585818≈7%

At 306, whether the two categories of products should be merged is determined by comparing the determined similarity between the two categories to a preset threshold. In the event that the determined similarity exceeds the preset threshold, at 308, the two categories of products are merged into one category. In the event that the determined similarity does not exceed the preset threshold, then the two categories of products are not merged.

In some embodiments, a preset threshold is used to determine whether two categories are similar enough to merge into one category. The preset threshold may be stored and accessed for the determination of step 304.

Returning to the previous example, where the determined similarity between the two categories of products is approximately 7%. Assuming that the preset threshold for merging two categories is 97% in this example, because the determined similarity is far below the threshold, the two categories will not be merged.

In some embodiments, merging two categories includes creating a new category identifier and storing the identifier with all the products of both categories (e.g., with identifying information for the products) and the related product data of both categories. In some embodiments, merging two categories includes storing all the products of both categories and the related product data of both categories with one of the category identifiers of the two categories.

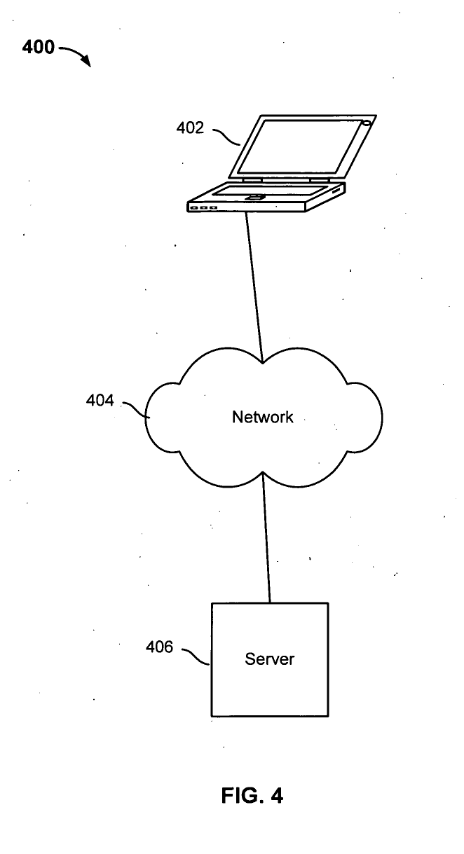

FIG. 4 is a diagram showing an embodiment of a system for categorizing and using product data. System 400 includes user 402, network 404, and server 406. Network 404 includes various high speed data networks and/or telecommunications networks. Server 406 is configured to communicate to user 402 through network 404.

In some embodiments, process 200 is carried out using system 400. In some embodiments, process 300 is also carried out using system 400. In some embodiments, the units (extraction unit 10, segment unit 11, selection unit 12, combination unit 13, and processing unit 14) of system 100 are components of server 406.

In some embodiments, server 406 is configured to support a platform for an electronic commerce website. For example, server 406 stores information for the website and also hosts webpages of the website. In some embodiments, server 406 is configured to acquire data from a user (e.g., user 402) who uploads information (e.g., product data) to the website.

Server 406 is configured to extract the titles of the products for which product data was acquired. In some embodiments, server 406 is configured to also extract the attribute information of the products from the acquired data. Server 406 can extract title and/or attribute information by, for example, from the respective title and attribute fields of the data uploaded at the website. Server 406 is configured to segment the extracted information (e.g., titles and/or attribute information) into phrases. For example, a title of a product can be segmented based on a set of rules that separate a string of alphanumeric words into one or more phrases. Server 406 is configured to determine scores for the phrases. In some embodiments, a score for a phrase is based on a historical frequency of the phrase's occurrence (e.g., in the stored product data at the website). Server 406 is configured to compose word sequences for the products of the acquired data. For example, a word sequence is composed for each product. In some embodiments, a word sequence is determined for a product based on selected ones of the product's phrases. The phrases can be selected based on a preset condition (e.g., the three phrases with the highest scores are selected). Server 406 is configured to compare the word sequence for a product to the word sequences of other products. In some embodiments, the word sequence for a product is compared to the word sequence of every other product in the acquired data. In some embodiments, a comparison of two word sequences results in whether the word sequences (and their corresponding products) are similar. Server 406 is configured to combine at least two products into the same category based at least in part on the results of the comparisons. In some embodiments, products that have word sequences that are deemed to be similar in the comparisons are combined in the same category. For example, products combined into the same category are stored under the same category identifier. In some embodiments, the product data (e.g., titles and attribute information) of the products in the same category are also stored under the same category identifier.

In some embodiments, server 406 is configured to merge categories of products. In some embodiments, server 406 is configured to determine a word combination for a category of products. For example, a word combination is determined for each existing category of products. The word combination can be selected from the word sequences associated with the products of the category. Server 406 is configured to determine a similarity between two categories of products. In some embodiments, the similarity is determined using the word combinations of the two categories. Server 406 is configured to compare the determined similarity between the two categories to a preset threshold to determine whether to merge the categories. If the determined similarity is above the preset threshold, then the two categories are merged into one category (e.g., and products from both categories are stored with the same category identifier). Otherwise, if the determined similarity is below the preset threshold, then the two categories are not merged.

Server 406 is configured to store and maintain the categories of products information. Such information may be used to represent each category of similar products at the electronic commerce website. For example, a visual presentation or table including title and attribute information for a category of products may be displayed in response to a user's search for products within that category. For instance, at the electronic commerce website, a user enters in “mobile phone” in a search box. The server supporting the website could return a set of search results including products sold at the website that relate to “mobile phone.” The returned search results can display stored information regarding categories of products that relate to “mobile phone” in the search results (e.g., in the form of visuals showing price, model, cost, manufacturers of products).

User 402 is a device through which a user accesses the electronic commerce website. While user 402 is shown as a laptop in FIG. 4, user 402 may also include any computer, mobile device, or tablet, among others. In some embodiments, user 402 is configured to allow a user to upload product data at the electronic commerce website. In some embodiments, user 402 is configured to receive search queries. In some embodiments, user 402 is configured to display search results.

It will be appreciated that one skilled in the art may make various modifications and alterations to the embodiments of the invention without departing from the spirit and scope of the present invention. Accordingly, if these modifications and alterations to the embodiments of the invention fall within the scope of the claims of the invention and their equivalents, the invention also intends to include all these modifications and alterations.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for categorizing products, comprising:
extracting titles for a plurality of products from acquired data;
segmenting the titles into phrases;
determining respective scores for the phrases;
composing a first word sequence that corresponds to a first one of the plurality of products using at least one of the phrases selected based at least in part on the determined respective scores for the phrases;
comparing the first word sequence to a second word sequence that corresponds to a second one of the plurality of products; and
combining the first one and the second one of the plurality of products into a category of products based at least in part on the comparison.

2. The method of claim 1, further comprising:
determining a similarity between a first category of products and a second category of products; and
in the event that the determined similarity at least meets a merging threshold, merging the first category of products with the second category of products.

3. The method of claim 1, wherein determining respective scores for the phrases is based at least in part on a historical occurrence frequency of a phrase.

4. The method of claim 1, further comprising extracting attribute information for the plurality of products from acquired data and segmenting the attribute information into phrases.

5. The method of claim 1, wherein comparing the first word sequence to a second word sequence for a second one of the plurality of products includes determining whether the first word sequence is similar to the second word sequence.

6. The method of claim 5, wherein determining whether the first word sequence is similar to the second word sequence is based at least in part on a match percentage.

7. The method of claim 1, wherein combining the first one and the second one of the plurality of products into a category of products includes combining data associated with the first one and second one of the plurality of products.

8. The method of claim 1, wherein combining the first one and the second one of the plurality of products into a category of products includes storing both of the first one and the second one of the plurality of products with a single category identifier.

9. The method of claim 2, wherein determining a similarity includes calculating a value based on determined scores corresponding to the first category of products and determined scores corresponding to the second category of products.

10. The method of claim 2, wherein merging the first category of products with the second category of products includes storing the first and the second category of products with a same category identifier.

11. A system for categorizing products, comprising:
one or more processors configured to:
extract titles for a plurality of products from acquired data;
segment the titles into phrases;
determine respective scores for the phrases;
compose a first word sequence that corresponds to a first one of the plurality of products using at least one of the phrases selected based at least in part on the determined respective scores for the phrases;
compare the first word sequence to a second word sequence that corresponds to a second one of the plurality of products; and
combine the first one and the second one of the plurality of products into a category of products based at least in part on the comparison; and
a memory coupled to the one or more processors and configured to provide the one or more processors with instructions.

12. The system of claim 11, further comprising the one or more processors configured to:
determine a similarity between a first category of products and a second category of products; and
merge the first category of products with the second category of products based on whether the determined similarity exceeds a merging threshold.

13. The system of claim 11, wherein the one or more processors configured to determine respective scores for the phrases based at least in part on a historical occurrence frequency of a phrase.

14. The system of claim 11, further comprising the one or more processors configured to extract attribute information for the plurality of products from acquired data and segment the attribute information into phrases.

15. The system of claim 11, wherein the one or more processors configured to compare the first word sequence to a second word sequence for a second one of the plurality of products includes determining whether the first word sequence is similar to the second word sequence.

16. The system of claim 15, wherein the one or more processors configured to determine whether the first word sequence is similar to the second word sequence based at least in part on a match percentage.

17. The system of claim 11, wherein the one or more processors configured to combine the first one and the second one of the plurality of products into a category of products includes combining data associated with the first one and second one of the plurality of products.

18. The system of claim 11, wherein the one or more processors configured to combine the first one and the second one of the plurality of products into a category of products includes storing both of the first one and the second one of the plurality of products with a same category identifier.

19. The system of claim 11, wherein the one or more processors configured to determine a similarity includes calculating a value based on determined scores corresponding to the first category of products and determined scores corresponding to the second category of products.

20. The system of claim 12, wherein the one or more processors configured to merge the first category of products with the second category of products includes storing the first and the second category of products with a single category identifier.

21. A computer program product for categorizing products, the computer program product being embodied in a computer readable storage medium and comprising computer instructions for:
extracting titles for a plurality of products from acquired data;
segmenting the titles into phrases;
determining respective scores for the phrases;
composing a first word sequence that corresponds to a first one of the plurality of products using at least one of the phrases selected based at least in part on the determined respective scores for the phrases;
comparing the first word sequence to a second word sequence that corresponds to a second one of the plurality of products; and
combining the first one and the second one of the plurality of products into a category of products based at least in part on the comparison.
